(19) United States
(12) Patent Application Publication
(10) Pub. No.: US 2022/0361066 A1
(43) Pub. Date: Nov. 10, 2022

(54) INFERENCE BASED NEIGHBOR RELATION CONFIGURATION

(71) Applicant: AT&T Intellectual Property I, L.P., Atlanta, GA (US)

(72) Inventors: Yupeng Jia, Austin, TX (US); Hongyan Lei, Plano, TX (US); Slawomir Stawiarski, Carpentersville, IL (US); Ye Chen, Marietta, GA (US)

(21) Appl. No.: 17/308,234

(22) Filed: May 5, 2021

(51) Int. Cl. H04W 36/00; H04W 16/10; H04W 48/18

(52) U.S. Cl. CPC H04W 36/00835; H04W 16/10; H04W 48/18; H04W 36/0061; H04W 36/0072

(57) ABSTRACT

The described technology is generally directed towards inference based neighbor relation configuration. A cell can obtain neighbor cell inference information, and the cell can use the neighbor cell inference information to ascertain identities of its neighbor relations. The neighbor cell inference information can include, e.g., neighbor information available from the cell's neighbors, neighbor information available from cells that share a base station with the cell, neighbor information available from cells that share a spectrum channel with the cell, neighbor information available from cells that share a base station with the cell's neighbors, or other neighbor cell inference information described herein.

### TECHNICAL FIELD

The subject application is related to fifth generation (5G), and subsequent generation cellular communication systems, e.g., to configuration of neighbor relations for 5G cells.

### BACKGROUND

A cellular communication network comprises cells, each of which can be understood, in one sense, as a geographical area served by particular network equipment, such as a base station. User equipment, such as a cellular telephone, can move from a first cell to a neighbor cell, and handoff procedures allow the cellular telephone to discontinue communications with a base station that supported the first cell, and initiate communications with a base station that supports the neighbor cell.

In another sense, the term “cell” is used in the wireless communication industry, as well as in this disclosure, to refer to the network equipment that provides cellular communications connectivity within a geographical cell. Network equipment can optionally include one cell or multiple cells, and hosting multiple cells can result in overlapping geographical cells. For example, a fourth generation (4G) cell as well as a 5G cell can potentially be included at a single base station. Likewise, multiple 4G and/or 5G cells can optionally be included at a single base station.

Network equipment that supports a cell can be configured to maintain a list of its neighbor cells, e.g., the cell's neighbor relations. A cell can provide neighbor relation information to user equipment to facilitate handoff procedures. Conventionally, network operators have manually configured neighbor relations for each cell in their network. However, manual neighbor relation configuration is tedious and error prone, as it requires operators to manually investigate and configure neighbor relations for each cell.

Techniques to automate neighbor relation measurement exist for 4G long term evolution (LTE) networks. However, relying exclusively on 4G techniques to perform automatic neighbor relation measurement in 5G new radio (NR) networks is not ideal. First, 4G LTE networks are relatively mature and stable, and so new neighbor cells are added relatively infrequently. In contrast, 5G networks are in a stage of rapid deployment, in which new neighbor cells are being added much more frequently. As a result, the overhead associated with 4G automatic neighbor relation measurement is more burdensome in the context of 5G networks. Second, it is preferable to avoid redundant automatic neighbor relation measurement work in 5G networks, if some of that work is already done in the 4G network, particularly since 5G and 4G sites are often co-located, and may even dynamically share a same frequency channel. New approaches to automatic neighbor relation measurement are desired for 5G networks.

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates an example cell configured for inference based neighbor relation configuration, in accordance with various aspects and embodiments of the subject disclosure.

FIG. 3 illustrates an example network node configured for inference based neighbor relation configuration, in accordance with various aspects and embodiments of the subject disclosure.

FIG. 4 illustrates a first example scenario for inference based neighbor relation configuration, in accordance with various aspects and embodiments of the subject disclosure.

FIG. 5 illustrates a second example scenario for inference based neighbor relation configuration, in accordance with various aspects and embodiments of the subject disclosure.

FIG. 6 illustrates a third example scenario for inference based neighbor relation configuration, in accordance with various aspects and embodiments of the subject disclosure.

FIG. 7 is a flow diagram representing example operations of network equipment, in accordance with various aspects and embodiments of the subject disclosure.

FIG. 8 is a flow diagram representing further example operations of network equipment, in accordance with various aspects and embodiments of the subject disclosure.

FIG. 9 is a flow diagram representing further example operations of network equipment, in accordance with various aspects and embodiments of the subject disclosure.

FIG. 10 is a flow diagram representing further example operations of network equipment, in accordance with various aspects and embodiments of the subject disclosure.

FIG. 11 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards inference based neighbor relation configuration. In some examples, a cell can obtain neighbor cell inference information, and the cell can use the neighbor cell inference information to ascertain identities of the cell's neighbor relations. The neighbor cell inference information can include, e.g., neighbor information available from the cell's neighbors, neighbor information available from cells that share a base station with the cell, neighbor information available from cells that share a spectrum channel with the cell, neighbor information available from cells that share a base station with the cell's neighbors, or other neighbor cell inference information as described herein.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments have been described herein in the context of 4G, 5G, or other next generation networks, the disclosed aspects are not limited to a 4G or 5G implementation, and/or other network next generation implementations, as the techniques can also be applied, for example, in third generation (3G), or other 4G systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), LTE frequency division duplex (FDD), time division duplex (TDD), 5G, third generation partnership project 2 (3GPP2), ultra mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology. In this regard, all or substantially all aspects disclosed herein can be exploited in legacy telecommunication technologies.

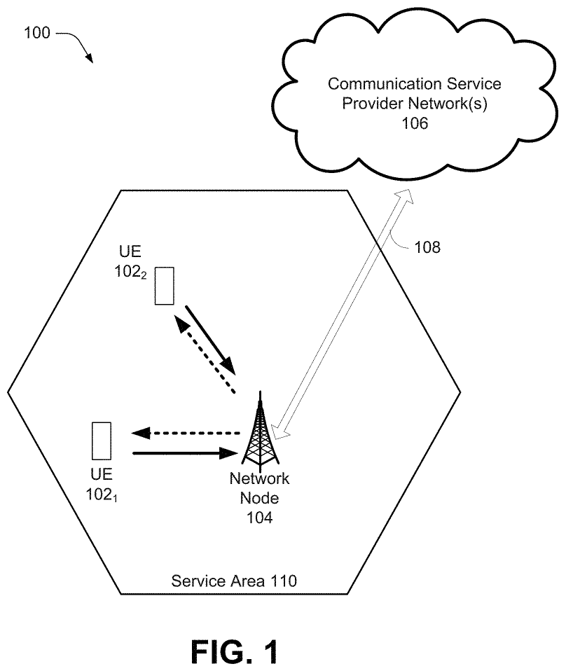

FIG. 1 illustrates a non-limiting example of a wireless communication system 100 which can be used in connection with at least some embodiments of the subject disclosure. In one or more embodiments, system 100 can comprise one or more user equipment UEs 1021, 1022, referred to collectively as UEs 102, a network node 104 that supports cellular communications in a service area 110, also known as a cell, and communication service provider network(s) 106.

The non-limiting term “user equipment” can refer to any type of device that can communicate with a network node 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network node 104. The network node 104 (e.g., network node device) can communicate with UEs 102, thus providing connectivity between the UEs 102 and the wider cellular network. The UEs 102 can send transmission type recommendation data to the network node 104. The transmission type recommendation data can comprise a recommendation to transmit data via a closed loop multiple input multiple output (MIMO) mode and/or a rank-1 precoder mode.

A network node 104 can have a cabinet and other protected enclosures, computing devices, an antenna mast, and multiple antennas for performing various transmission operations (e.g., MIMO operations) and for directing/steering signal beams. Network node 104 can comprise one or more base station devices which implement features of the network node 104. Network nodes can serve several cells, also called sectors or service areas, such as service area 110, depending on the configuration and type of antenna. In example embodiments, UEs 102 can send and/or receive communication data via a wireless link to the network node 104. The dashed arrow lines from the network node 104 to the UEs 102 can encode downlink (DL) communications to the UEs 102. The solid arrow lines from the UEs 102 to the network node 104 represent uplink (UL) communications.

Communication service provider networks 106 can facilitate providing wireless communication services to UEs 102 via the network node 104 and/or various additional network devices (not shown) included in the one or more communication service provider networks 106. The one or more communication service provider networks 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider networks 106 can be or comprise the wireless communication network and/or various additional devices and components of the wireless communication network (e.g., additional network devices and cell, additional UEs, network server devices, etc.).

The network node 104 can be connected to the one or more communication service provider networks 106 via one or more backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). Backhaul links 108 can be implemented via a “transport network” in some embodiments. In another embodiment, network node 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UE 102 and the network node 104). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 100 can operate in accordance with any 5G, next generation communication technology, or existing communication technologies, various examples of which are listed supra. In this regard, various features and functionalities of system 100 are applicable where the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

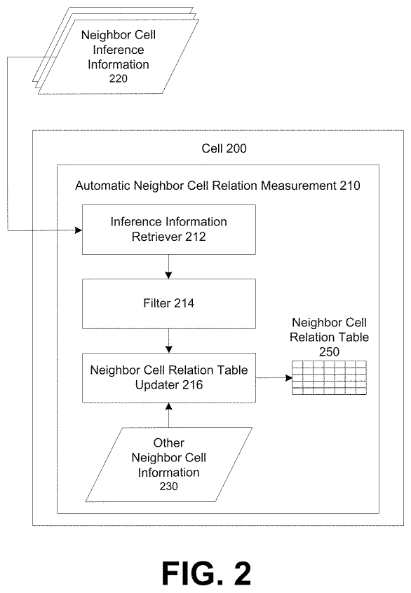

FIG. 2 illustrates an example cell configured for inference based neighbor relation configuration, in accordance with various aspects and embodiments of the subject disclosure. The example cell 200 can be included, e.g., at a network node 104 such as introduced in FIG. 1. As such, the cell 200 can support wireless communications of UEs 102 within the service area 110. The cell 200 can include, inter alia, automatic neighbor relation measurement 210. Automatic neighbor relation measurement 210 can include inference information retriever 212, wherein inference information retriever 212 can retrieve neighbor cell inference information 220. Automatic neighbor relation measurement 210 can furthermore include filter 214, neighbor cell relation table updater 216, other neighbor cell information 230, and neighbor cell relation table 250.

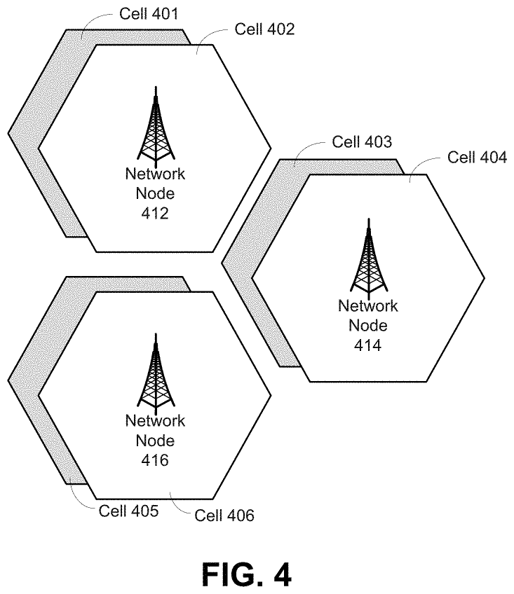

In an example according to FIG. 2, neighbor cell inference information 220 can comprise, e.g., another cells' neighbor relations. For example, if another cell, other than cell 200, has neighbors 1, 2, and 3, then the neighbor cell inference information 220 can identify neighbors 1, 2, and 3. Example scenarios are disclosed in further detail in connection with FIGS. 4, 5, and 6.

Inference information retriever 212 can be configured to retrieve neighbor cell inference information 220 from another cell, such as from a neighbor of cell 200, or from another source, such as from a component of communication service provider network(s) 106. Filter 214 can be configured to remove unnecessary neighbor relations from neighbor cell inference information 220, wherein the unnecessary neighbor relations can comprise neighbor relations that are not needed for the cell's 200 neighbor cell relation table 250, either because the unnecessary neighbor relations are redundant, or because the unnecessary neighbor relations are otherwise not appropriate for inclusion in the neighbor cell relation table 250.

Neighbor cell relation table updater 216 can be configured to include neighbor relations, as optionally filtered by filter 214, in the cell's 200 neighbor relation table 250. Neighbor cell relation table updater 216 can furthermore be configured to add other neighbor cell information 230, e.g., neighbor relations identified by any other means, in the neighbor cell relation table 250.

In some embodiments, automatic neighbor cell relation measurement 210 can be implemented within communication service provider network(s) 106, instead of within cell 200. For example, automatic neighbor cell relation measurement 210 can be implemented at a RAN intelligent controller (RIC) of communication service provider network(s) 106. In such embodiments, the RIC can be configured to identify a cell, such as 200, and automatic neighbor cell relation measurement 210 can retrieve neighbor cell inference information 200 for the identified cell 200. The RIC can send neighbor cell relation table 250, or neighbor relation information for inclusion in the neighbor cell relation table 250, to the cell 200.

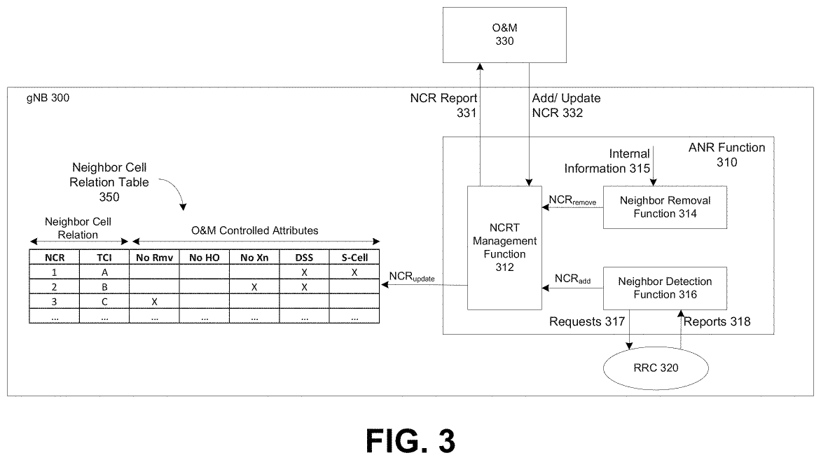

FIG. 3 illustrates an example network node configured for inference based neighbor relation configuration, in accordance with various aspects and embodiments of the subject disclosure. The example gNodeB (gNB) 300 network node can implement, e.g., the network node 104 introduced in FIG. 1. The gNB 300 comprises an automatic neighbor relation (ANR) function 310, which can implement the inference based techniques disclosed herein. The ANR function 310 updates a neighbor cell relation table 350. The ANR function 310 can communicate with operations and management (O&M) 330, wherein O&M 330 can be included in communication service provider network(s) 106 (see FIG. 1). The ANR function 310 can furthermore communicate with a radio resource control (RRC) module 320 included in the gNB 300.

In FIG. 3, the ANR function 310 includes a neighbor detection function 316, a neighbor removal function 314, and a neighbor cell relation table (NCRT) management function 312. The neighbor cell detection function 316 can be configured to send requests 317 to RRC 320. When the neighbor cell detection function 316 is configured according to this disclosure, the requests 317 can comprise requests for neighbor cell inference information. Reports 318 returned from RRC 320 can comprise the requested neighbor cell inference information. The neighbor cell detection function 316 can be configured to generate NCR_{add} based on the reports 318, and to provide NCR_{add} to the NCRT management function 312. NCR_{add} can comprise identifications of neighbor cells to add to the neighbor cell relation table 350.

The neighbor removal function 314 can be configured to generate NCRᵣₑₘₒᵥₑ based on internal information 315, and neighbor removal function 314 can provide NCRᵣₑₘₒᵥₑ to the NCRT management function 312. The NCRT management function 312 can be configured to update the neighbor cell relation table 350 via NCR_{update}. For example, the NCRT management function 312 can be configured to add neighbor cell relations to the neighbor cell relation table 350 based on NCR_{add}, and to remove neighbor cell relations from the neighbor cell relation table 350 based on NCRᵣₑₘₒᵥₑ. The NCRT management function 312 can furthermore be configured to provide a neighbor cell relations (NCR) report 331 to O&M 330, and to receive add/update NCR 332 from O&M 330. The NCRT management function 312 can add, remove, or update entries in the neighbor cell relation table 350 pursuant to add/update NCR 332 instructions from O&M 330.

In an example embodiment, the neighbor cell relation table 350 can comprise an NCR column, a target cell identity (TCI) column, a no remove (No Rmv) column, a no handover (no HO) column, a no Xn column, a dynamic spectrum sharing (DSS) column, and a secondary cell (S-Cell) column. The NCR and TCI columns can identify a neighbor cell relation, and the remaining columns can comprise O&M controlled attributes associated with each neighbor cell relation. When No Rmv is flagged, the gNB 300 may not remove the neighbor cell relation from the neighbor cell relation table 350. When no HO is flagged, the gNB 300 may not use the neighbor cell relation for handovers. When no Xn is flagged, the gNB 300 may not use an X2 interface (or other Xn type interface) in order to initiate procedures involving a network node that hosts the neighbor cell relation.

The additional DSS column and S-Cell column illustrated in FIG. 3 can be used in connection with some embodiments of this disclosure. When DSS is flagged, the neighbor cell relation is on a DSS carrier, which can impact use of neighbor cell inference information according to embodiments of this disclosure, e.g., in scenarios such as described in connection with FIG. 4. When S-Cell is flagged, the neighbor cell relation is a secondary cell (and not a primary cell) which can also impact use of neighbor cell inference information according to embodiments of this disclosure. The DSS column and S-Cell column illustrated in FIG. 3 are novel aspects of a neighbor cell relation table 350, and embodiments of this disclosure can comprise generating, reading, and/or using a DSS column and/or an S-Cell column in a neighbor cell relation table 350 in connection with automatic neighbor relation detection.

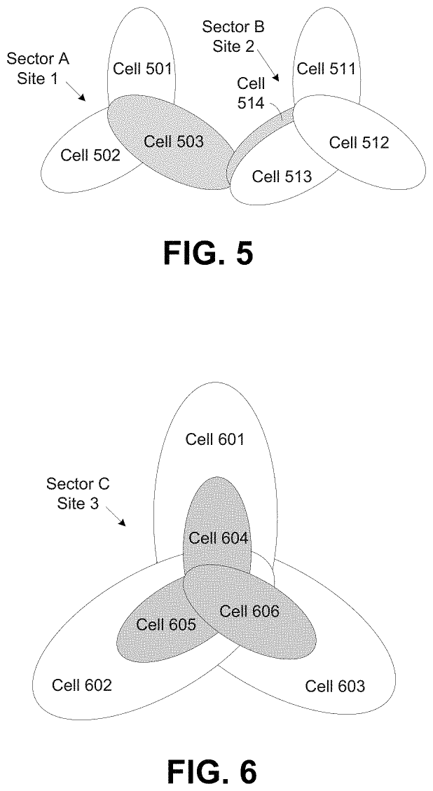

FIG. 4, FIG. 5, and FIG. 6 illustrate example scenarios for inference based neighbor relation configuration, in accordance with various aspects and embodiments of the subject disclosure. In general, with regard to FIG. 4, FIG. 5, and FIG. 6, the inference based neighbor relation configuration techniques disclosed herein can reduce the burden associated with automatic neighbor relation measurements by 5G NR network nodes, by leveraging existing 4G LTE network node automatic neighbor relation measurements. Both 4G node to 4G node (LTE-LTE) measurements, and 4G node to 5G node (LTE-NR) measurements can be leveraged. Techniques disclosed herein can thereby reduce network operation costs, reduce air interface signaling overhead, and reduce device measurement of neighboring cells thereby extending device battery life of UEs.

In some embodiments, techniques according to this disclosure can use artificial intelligence to filter cross-RAT ANR reports based on an operator's deployment scenarios and band combinations. Algorithms can retrieve NR-NR neighbor relations, leveraging LTE-LTE ANR measurements and LTE-NR ANR measurements in LTE and 5G non-standalone (NSA) deployments.

Embodiments of this disclosure can derive 5G NR neighbor cell lists for 5G standalone deployments by, first, automatically adding a 5G NR neighbor cell list via leveraging LTE-LTE and LTE-NR cell relations. Second, embodiments can optionally intelligently filter LTE-LTE and LTE-NR cell relations information, in order to determine 5G NR carriers that are running LTE/NR dynamic spectrum sharing (DSS). Third, embodiments can optimize the model and solution for quick 5G standalone rollout.

FIG. 4 illustrates a first example scenario for inference based neighbor relation configuration, in accordance with various aspects and embodiments of the subject disclosure. FIG. 4 includes three example network nodes—a network node 412, and two example neighbor nodes, including network node 414 and network node 416. Each of the example network nodes 412, 414, and 416 can use DSS to support both a 4G LTE cell, and a 5G NR cell. Thus, network node 412 supports a 4G cell 402, and a 5G cell 401. Network node 414 supports a 4G cell 404, and a 5G cell 403. Network node 416 supports a 4G cell 406, and a 5G cell 405.

In a scenario such as illustrated in FIG. 4, a 5G cell 401 can be configured to add NR-NR neighbor relations, e.g., neighbor relations between cell 401 and cells 403 and 405, based on LTE-LTE ANR determinations, namely, ANR determinations made by cell 402 whereby cell 402 identifies its LTE neighbors 404 and 406.

In order to implement neighbor determinations by the 5G cell 401, embodiments can leverage a DSS attribute in a neighbor cell relation table 350. Both the 4G eNBs that support cells 402, 404, and 406, and the 5G gNBs that support cells 401, 403, and 405, can include DSS attribute columns in their respective neighbor cell relation tables.

When an NR cell, such as cell 401, is on a DSS carrier, the cell 401 can be configured to check the neighbor relation table of its shared LTE carrier, namely the neighbor relation table of cell 402. When an LTE cell 402 is on DSS carrier, if its LTE neighbor 404 is also on DSS carrier, this means that both cell 402 and cell 404 have NR carriers. Therefore, NR cell 401 and NR cell 403 can add each other as neighbors based on the existing LTE cell 402 to LTE cell 404 neighbor relation.

Furthermore, in a scenario such as illustrated by FIG. 4, the 5G cell 401 can be configured to automatically update its NR neighbor relations in response to LTE-LTE neighbor relations changes, e.g., in response to neighbor relations changes at cell 402.

FIG. 5 illustrates a second example scenario for inference based neighbor relation configuration, in accordance with various aspects and embodiments of the subject disclosure. FIG. 5 illustrates a 4G LTE cell 501, a 4G LTE cell 502, and a 5G NR cell 503, which share a site and sector, namely Sector A and Site 1. FIG. 5 furthermore illustrates a 4G LTE cell 511, a 4G LTE cell 512, a 4G LTE cell 513, and a 5G NR cell 514, which share a site and sector, namely Sector B and Site 2.

In the illustrated scenario, 5G NR cell 503 can be on a dedicated carrier (not a DSS carrier). The 5G NR cell 503 can be configured to add NR-NR neighbor relations based on NR-LTE ANR. The 5G NR cell 503 can make an NR-LTE ANR measurement, in order automatically add 4G LTE cell 513 to 5G NR cell 503's neighbor relation table. When 5G NR cell 503 is on dedicated carrier and has established a neighbor relation with an LTE carrier, such as 4G LTE cell 513, via an NR-LTE ANR measurement, the 5G NR cell 503 can be configured to check if there are other NR carriers, such as 5G NR cell 514, at the same site and sector (here, Sector B and Site 2) as the neighbor LTE carrier (4G LTE cell 513). If yes, the 5G NR cell 503 can be configured to add the NR carriers, such as 5G NR cell 514, to the neighbor relations table for 5G NR cell 503. Furthermore, 5G NR cell 503 can be configured to automatically update its neighbor relations in response to a NR-LTE neighbor relation change, e.g., in response to the 5G NR cell 503 discontinuing its neighbor relationship with 4G LTE cell 513.

In some embodiments, a cell such as cell 503 can be configured determine site and/or sector of a neighbor cell, such as cell 513, using geolocation identification techniques. Furthermore, antenna directions associated with cell 503 and/or cell 514 can be used to determine whether cell 503 may add cell 514 as a neighbor. For example, in FIG. 5, cell 514 has an antenna direction which is at least partially opposite the antenna direction of cell 503. A 5G NR cell 503 can be configured to add a neighbor 514 when the neighbor 514 antenna direction is at least partially opposite its own antenna direction, or the 5G NR cell 503 can discard a neighbor candidate when the neighbor candidate's antenna direction is not at least partially in an opposing direction.

FIG. 6 illustrates a third example scenario for inference based neighbor relation configuration, in accordance with various aspects and embodiments of the subject disclosure. FIG. 6 includes a 4G LTE cell 601, a 4G LTE cell 602, a 4G LTE cell 603, a 5G NR cell 604, a 5G NR cell 605, and a 5G NR cell 606, wherein all of the illustrated cells share a site and sector, namely Sector C and Site 3.

In an example according to FIG. 6, the 5G NR cells 604, 605, and 606 can each be on a dedicated carrier, such as a mid- or high-band carrier. A 5G NR cell, such as cell 604, can be configured to add NR-NR neighbor relations for collocated NR carriers, for example, 5G NR cell 604 can add 5G NR cells 605 and 606 to 5G NR cell 604's neighbor relation table. If there are multiple NR carriers at a same site and/or sector, as illustrated in FIG. 6, the NR carriers can be configured to add each other as neighbors for intra-site mobility.

In some embodiments, scenario overlap can occur, for example, aspects of FIG. 4, FIG. 5, and/or FIG. 6 can coexist. In such scenario overlap situations, operations to add neighbors can include multiple different inference information retrieval and processing operations, for example, in order to add neighbors in accordance with any to any two or more of FIG. 4, FIG. 5, and/or FIG. 6.

The neighbor determinations for network nodes in scenarios illustrated in FIG. 4, FIG. 5, and FIG. 6 can be made at the network nodes themselves, or such neighbor determinations can optionally be made within communication service provider network(s) 106, e.g., at a RAN intelligent controller (RIC) or other core network device, as will be appreciated. If processing is conducted at a core network element, such as a RIC, then information described herein can be sent from RAN network nodes comprising the illustrated cells to the core network element for processing, and the core network element can be configured to return updated neighbor relation information to RAN network nodes.

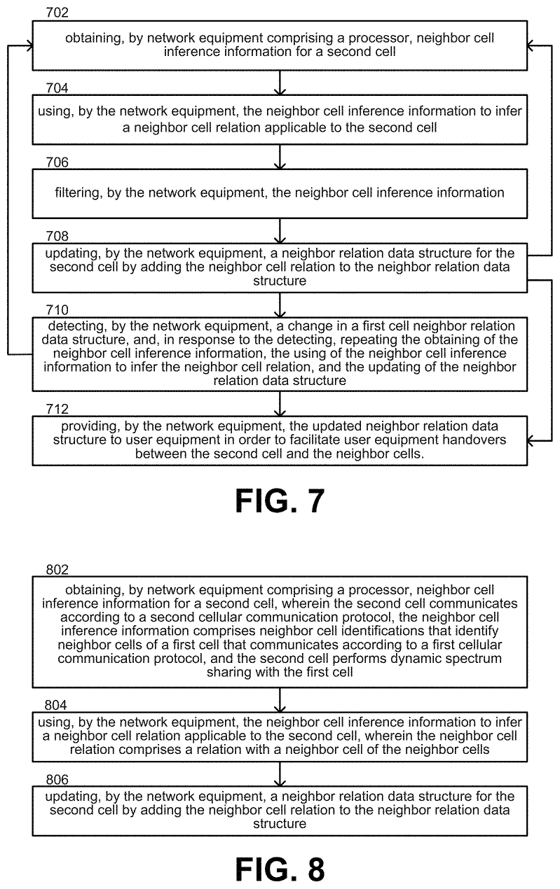

FIG. 7 is a flow diagram representing example operations of network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

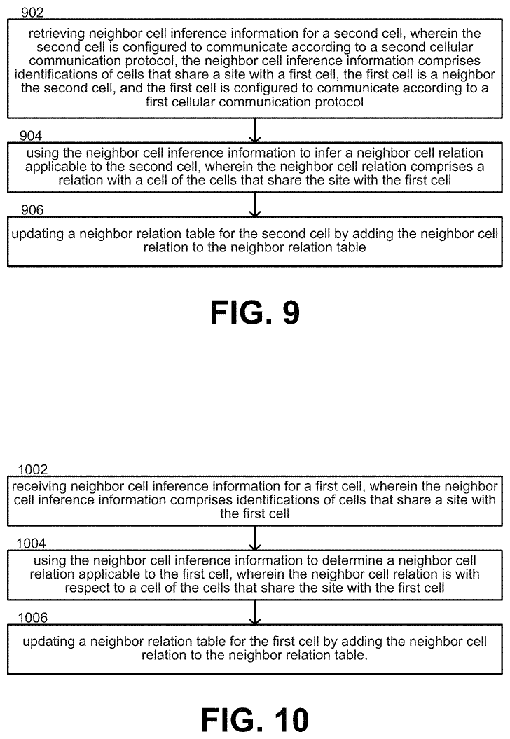

The operations illustrated in FIG. 7, as well as FIG. 8, FIG. 9, and FIG. 10, can be performed, for example, by network equipment such as a network node 104 introduced in FIG. 1, or by a device within the communication service provider network(s) 106, e.g., by a RAN intelligent controller (RIC) within the communication service provider network(s) 106. The operations illustrated in FIG. 7 provide a general example, while FIG. 8, FIG. 9, and FIG. 10 provide more specific examples, each of which follows the general operations introduced in FIG. 7 while being designed for deployment in scenarios such as illustrated in FIG. 4, FIG. 5, and FIG. 6, respectively.

Example operation 702 comprises obtaining, by network equipment comprising a processor, neighbor cell inference information for a second cell. The neighbor cell inference information can include, e.g. neighbors of a first cell, or identifications of cells at a same site as a first cell, as described further in connection with FIG. 8, FIG. 9, and FIG. 10. Example operation 704 comprises using, by the network equipment, the neighbor cell inference information to infer a neighbor cell relation applicable to the second cell. Example operation 706 comprises filtering, by the network equipment, the neighbor cell inference information. In some embodiments, filtering can comprise removing redundant neighbor cell identifications that identify previous neighbor cells that were previously included in the second cell's neighbor relation table. Example operation 708 comprises updating, by the network equipment, a neighbor relation data structure for the second cell by adding the neighbor cell relation to the neighbor relation data structure, resulting in an updated neighbor relation data structure.

The operations 702-708 can optionally be repeated as desired, while modifying the operations 702-708 in order to gather additional inference information and potentially add further neighbor cells to the neighbor relation data structure. For example, the operations of FIG. 8, FIG. 9, or FIG. 10 can optionally be performed first, the operations of a second one of FIG. 8, FIG. 9, or FIG. 10 can optionally be performed next, and the operations a third one of FIG. 8, FIG. 9, or FIG. 10 can optionally be performed next. Furthermore, each time a neighbor relation data structure for the second cell is updated pursuant to operations 702-708, operation 712 can optionally be performed. Operation 712 includes providing, by the network equipment, the updated neighbor relation data structure to user equipment in order to facilitate user equipment handovers between the second cell and the neighbor cells. For example, when the network equipment is a network node that supports the second cell, the network equipment can provide the updated neighbor relation data structure to any user equipment that connects to the second cell.

Example operation 710 comprises detecting, by the network equipment, a change in a first cell neighbor relation data structure, and, in response to the detecting, repeating the obtaining of the neighbor cell inference information, the using of the neighbor cell inference information to infer the neighbor cell relation, and the updating of the neighbor relation data structure. For example, when the first cell is a cell relied upon for inference information pursuant to FIG. 8, FIG. 9, or FIG. 10, then operations according to FIG. 8, FIG. 9, or FIG. 10, as appropriate, can be repeated in response to a change in the first cell neighbor relation data structure. Furthermore, each time a neighbor relation data structure for the second cell is updated pursuant to operation 710, operation 712 can optionally be performed, as described above.

FIG. 8 is a flow diagram representing further example operations of network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 8 can be performed, e.g., in scenarios such as illustrated in FIG. 4. Example operation 802 comprises obtaining, by network equipment comprising a processor, such as network node 412, neighbor cell inference information for a second cell, e.g., cell 401, wherein the second cell 401 communicates according to a second cellular communication protocol, such as 5G, wherein the neighbor cell inference information comprises neighbor cell identifications that identify neighbor cells, e.g., neighbor cells 403, 404, 405 and/or 406 of a first cell, e.g., cell 402, that communicates according to a first cellular communication protocol, such as 4G, and wherein the second cell 401 performs dynamic spectrum sharing with the first cell 401.

The neighbor cell inference information obtained at operation 802 can comprise a first cell neighbor relation data structure, e.g., a neighbor relation data structure for first cell 402. The first cell neighbor relation data structure can comprise indications to indicate whether dynamic spectrum sharing is used at the neighbor cells 403, 404, 405 and/or 406. For example, the first cell neighbor relation data structure can include a DSS column such as illustrated in FIG. 3.

Example operation 804 comprises using, by the network equipment 412, the neighbor cell inference information to infer a neighbor cell relation applicable to the second cell 401, wherein the neighbor cell relation comprises a relation with a neighbor cell of the neighbor cells 403, 404, 405 and/or 406. In particular, the neighbor cell relation can comprises a relation with a 5G neighbor cell, such as 403 or 405. Example operation 806 comprises updating, by the network equipment 412, a neighbor relation data structure for the second cell 401 by adding the neighbor cell relation, with cell 403 and/or 405, to the neighbor relation data structure.

The operations of FIG. 8 can optionally be preceded or followed by FIG. 9 and/or FIG. 10, as described in connection with FIG. 7. The filtering, change detection, and user equipment communication operations 708, 710, 712 of FIG. 7 can also be included among operations in FIG. 8.

For example, should operations of FIG. 8 be followed by FIG. 9, further operations can include obtaining, by the network equipment 412, second neighbor cell inference information for the second cell 401, wherein the second neighbor cell inference information comprises identifications of cells, such as cells 511, 512, and 514, that share a site with a third cell, such as cell 513, and wherein the third cell 513 is a neighbor the second cell 401. Here, scenarios according to FIG. 4 and FIG. 5 are combined to situate cell 401 as cell 503, as will be appreciated. Another operation can include using, by the network equipment 412, the second neighbor cell inference information to infer a second neighbor cell relation applicable to the second cell 401, wherein the second neighbor cell relation comprises a second relation with a cell 514 of the cells 511, 512, and 514 that share the site with the third cell 513. Another operation can include updating, by the network equipment 412, the neighbor relation data structure for the second cell 401 by adding the second neighbor cell relation to the neighbor relation data structure.

Should operations of FIG. 8 be followed by FIG. 10, further operations can include obtaining, by the network equipment 412, second neighbor cell inference information for the second cell 401, wherein the second neighbor cell inference information comprises identifications of cells 601, 602, 603, 604, and 605 that share a site with the second cell 401. Here, scenarios according to FIG. 4 and FIG. 6 are combined to situate cell 401 as cell 606, as can be appreciated. The identifications of the cells 601, 602, 603, 604, and 605 that share the site with the second cell 401 can comprise identifications of cells that share a geolocation and an antenna direction with the second cell 401. Another operation can include using, by the network equipment 412, the second neighbor cell inference information to infer a second neighbor cell relation applicable to the second cell 401, wherein the second neighbor cell relation comprises a second relation with a cell 605 of the cells 601, 602, 603, 604, and 605 that share the site with the second cell 401. Another operation can include updating, by the network equipment 412, the neighbor relation data structure for the second cell 401 by adding the second neighbor cell relation to the neighbor relation data structure.

FIG. 9 is a flow diagram representing further example operations of network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, in scenarios such as illustrated in FIG. 5. Example operation 902 comprises retrieving neighbor cell inference information for a second cell 503, wherein the second cell 503 is configured to communicate according to a second cellular communication protocol, such as 5G, the neighbor cell inference information comprises identifications of cells 511, 512, and 514 that share a site and/or a sector with a first cell 513, the first cell 513 is a neighbor the second cell 503, and the first cell 513 is configured to communicate according to a first cellular communication protocol, such as 4G. In some embodiments, the neighbor cell inference information can comprise identifications of those of cells 511, 512, and 514 that share a geolocation with the first cell 513 and, optionally, also have an antenna direction at least partly opposite that of the second cell 503. In some embodiments, the identifications of the cells that share the site with the first cell 513 can comprise the identifications of the cells, such as cell 514, which are configured to communicate according to the second cellular communication protocol (e.g., 5G).

Example operation 904 comprises using the neighbor cell inference information to infer a neighbor cell relation applicable to the second cell 503 wherein the neighbor cell relation comprises a relation with a cell 514 of the cells 511, 512, and 514 that share the site with the first cell 503. Example operation 906 comprises updating a neighbor relation table for the second cell 503 by adding the neighbor cell relation to the neighbor relation table.

The operations of FIG. 9 can optionally be preceded or followed by FIG. 8 and/or FIG. 10, as described in connection with FIG. 7. The filtering, change detection, and user equipment communication operations 708, 710, 712 of FIG. 7 can also be included among operations in FIG. 9. For example, should operations of FIG. 9 be followed by FIG. 10, further operations can include retrieving second neighbor cell inference information for the second cell 503, wherein the second neighbor cell inference information comprises second identifications of second cells 601, 602, 603, 604, and 605 that share a site and/or a sector with the second cell 503. The second identifications of the second cells 601, 602, 603, 604, and 605 that share the site and/or sector with the second cell 503 can comprise the second identifications of the second cells that share a geolocation and an antenna direction with the second cell 503. Here, scenarios according to FIG. 5 and FIG. 6 are combined to situate cell 503 as cell 606, as can be appreciated.

Another operation can include using the second neighbor cell inference information to infer a second neighbor cell relation applicable to the second cell 503, wherein the second neighbor cell relation comprises a second relation with a second one, e.g. cell 605, of the second cells 601, 602, 603, 604, and 605 that share the second site with the second cell 503. Another operation can include updating the neighbor relation table for the second cell 503 by adding the second neighbor cell relation to the neighbor relation table.

FIG. 10 is a flow diagram representing further example operations of network equipment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 10 can be performed, for example, in scenarios such as illustrated in FIG. 6. Example operation 1002 comprises receiving neighbor cell inference information for a first cell 606, wherein the neighbor cell inference information comprises identifications of cells, e.g., cells 604 and 605, which share a site with the first cell 606. In some embodiments, the identifications of the cells 604 and 605 that share the site with the first cell 606 can comprise identifications of the cells that share a geolocation and an antenna direction with the first cell 606. In some embodiments, the first cell 606 and the cells 604 and 605 that share the site with the first cell 606 are configured to communicate according to a fifth generation cellular communication protocol.

Example operation 1004 comprises using the neighbor cell inference information to determine a neighbor cell relation applicable to the first cell 606, wherein the neighbor cell relation is with respect to a cell, e.g., cell 605 of the cells 604 and 605 that share the site with the first cell 606. Example operation 1006 comprises updating a neighbor relation table for the first cell 606 by adding the neighbor cell relation to the neighbor relation table.

The operations of FIG. 10 can optionally be preceded or followed by FIG. 8 and/or FIG. 9, as described in connection with FIG. 7. The filtering, change detection, and user equipment communication operations 708, 710, 712 of FIG. 7 can also be included among operations in FIG. 10.

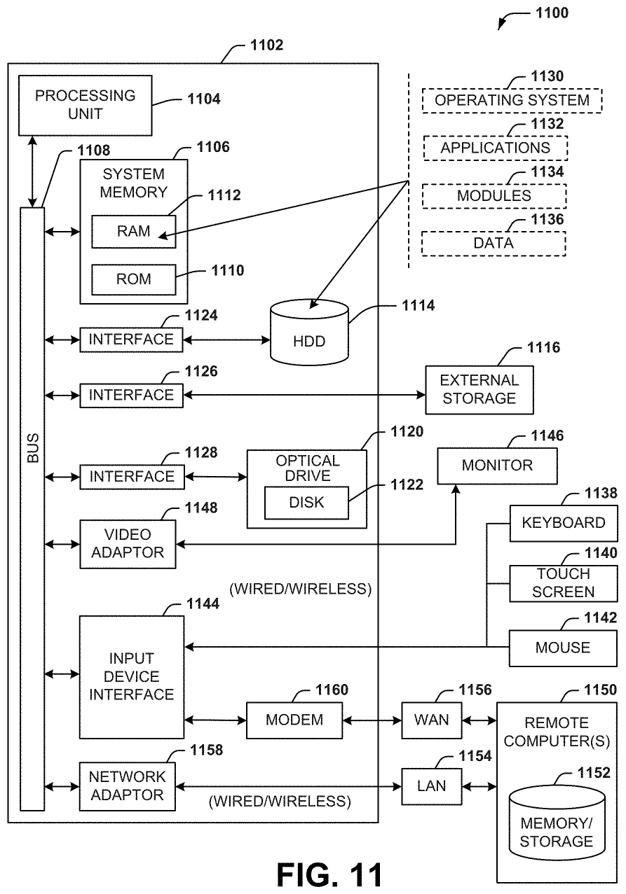

FIG. 11 is a block diagram of an example computer that can be operable to execute processes and methods in accordance with various aspects and embodiments of the subject disclosure. The example computer can be adapted to implement, for example, any of the various network equipment described herein.

FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), smart card, flash memory (e.g., card, stick, key drive) or other memory technology, compact disk (CD), compact disk read only memory (CD-ROM), digital versatile disk (DVD), Blu-ray™ disc (BD) or other optical disk storage, floppy disk storage, hard disk storage, magnetic cassettes, magnetic strip(s), magnetic tape, magnetic disk storage or other magnetic storage devices, solid state drives or other solid state storage devices, a virtual device that emulates a storage device (e.g., any storage device listed herein), or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by network equipment comprising a processor, neighbor cell inference information for a second cell, wherein:
the second cell communicates according to a second cellular communication protocol,
the neighbor cell inference information comprises neighbor cell identifications that identify neighbor cells of a first cell that communicates according to a first cellular communication protocol, and
the second cell performs dynamic spectrum sharing with the first cell;
using, by the network equipment, the neighbor cell inference information to infer a neighbor cell relation applicable to the second cell, wherein the neighbor cell relation comprises a relation with a neighbor cell of the neighbor cells; and
updating, by the network equipment, a neighbor relation data structure for the second cell by adding the neighbor cell relation to the neighbor relation data structure, resulting in an updated neighbor relation data structure.

2. The method of claim 1, wherein the relation with the neighbor cell of the neighbor cells is a first relation, and further comprising:
obtaining, by the network equipment, second neighbor cell inference information for the second cell, wherein:
the second neighbor cell inference information comprises identifications of cells that share a site with a third cell, and
the third cell is a neighbor the second cell;
using, by the network equipment, the second neighbor cell inference information to infer a second neighbor cell relation applicable to the second cell, wherein the second neighbor cell relation comprises a second relation with a cell of the cells that share the site with the third cell; and
updating, by the network equipment, the neighbor relation data structure for the second cell by adding the second neighbor cell relation to the neighbor relation data structure.

3. The method of claim 1, wherein the relation with the neighbor cell of the neighbor cells is a first relation, and further comprising:
obtaining, by the network equipment, second neighbor cell inference information for the second cell, wherein the second neighbor cell inference information comprises identifications of cells that share a site with the second cell;
using, by the network equipment, the second neighbor cell inference information to infer a second neighbor cell relation applicable to the second cell, wherein the second neighbor cell relation comprises a second relation with a cell of the cells that share the site with the second cell; and
updating, by the network equipment, the neighbor relation data structure for the second cell by adding the second neighbor cell relation to the neighbor relation data structure.

4. The method of claim 3, further comprising providing, by the network equipment, the updated neighbor relation data structure to user equipment in order to facilitate user equipment handovers between the second cell and the neighbor cells.

5. The method of claim 1, wherein the second cellular communication protocol comprises a fifth generation cellular communication protocol and the first cellular communication protocol comprises a fourth generation cellular communication protocol.

6. The method of claim 1, wherein the neighbor cell inference information comprises a first cell neighbor relation data structure, and wherein the first cell neighbor relation data structure comprises indications to indicate whether dynamic spectrum sharing is used at the neighbor cells.

7. The method of claim 6, further comprising detecting, by the network equipment, a change in the first cell neighbor relation data structure, and, in response to the detecting, repeating the obtaining of the neighbor cell inference information, the using of the neighbor cell inference information to infer the neighbor cell relation, and the updating of the neighbor relation data structure.

8. The method of claim 1, wherein the neighbor relation data structure is a neighbor relation table, and further comprising filtering, by the network equipment, the neighbor cell inference information to remove a redundant neighbor cell identification that identifies a previous neighbor cell that was previously included in the neighbor relation table.

9. Network equipment, comprising:
a processor; and
a memory that stores executable instructions that, when executed by the processor, facilitate performance of operations, comprising:
retrieving neighbor cell inference information for a second cell, wherein:
the second cell is configured to communicate according to a second cellular communication protocol,
the neighbor cell inference information comprises identifications of cells that share a site with a first cell,
the first cell is a neighbor the second cell, and
the first cell is configured to communicate according to a first cellular communication protocol;
using the neighbor cell inference information to infer a neighbor cell relation applicable to the second cell, wherein the neighbor cell relation comprises a relation with a cell of the cells that share the site with the first cell; and
updating a neighbor relation table for the second cell by adding the neighbor cell relation to the neighbor relation table.

10. The network equipment of claim 9, wherein the identifications of cells that share the site with the first cell are first identifications of first cells that share a first site with the first cell, wherein the relation with the cell of the cells is a first relation with a first one of the first cells, and wherein the operations further comprise:
retrieving second neighbor cell inference information for the second cell, wherein the second neighbor cell inference information comprises second identifications of second cells that share a second site with the second cell;
using the second neighbor cell inference information to infer a second neighbor cell relation applicable to the second cell, wherein the second neighbor cell relation comprises a second relation with a second one of the second cells that share the second site with the second cell; and
updating the neighbor relation table for the second cell by adding the second neighbor cell relation to the neighbor relation table.

11. The network equipment of claim 10, wherein the second identifications of the second cells that share the site with the second cell comprise the second identifications of the second cells that share a geolocation and an antenna direction with the second cell.

12. The network equipment of claim 9, wherein the neighbor cell inference information comprises the identifications of the cells that share the site and a sector with the first cell.

13. The network equipment of claim 9, wherein the identifications of the cells that share the site with the first cell comprise the identifications of the cells configured to communicate according to the second cellular communication protocol.

14. The network equipment of claim 9, wherein the network equipment comprises a radio access network intelligent controller.

15. The network equipment of claim 9, wherein the network equipment comprises a radio access network node.

16. A non-transitory machine-readable medium, comprising executable instructions that, when executed by a processor, facilitate performance of operations, comprising:
receiving neighbor cell inference information for a first cell, wherein the neighbor cell inference information comprises identifications of cells that share a site with the first cell;
using the neighbor cell inference information to determine a neighbor cell relation applicable to the first cell, wherein the neighbor cell relation is with respect to a cell of the cells that share the site with the first cell; and
updating a neighbor relation table for the first cell by adding the neighbor cell relation to the neighbor relation table.

17. The non-transitory machine-readable medium of claim 16, wherein the identifications of the cells that share the site with the first cell comprise the identifications of the cells that share a geolocation and an antenna direction with the first cell.

18. The non-transitory machine-readable medium of claim 16, wherein the first cell and the cells that share the site with the first cell are configured to communicate according to a fifth generation cellular communication protocol.

19. The non-transitory machine-readable medium of claim 16, wherein a radio access network intelligent controller comprises the processor.

20. The non-transitory machine-readable medium of claim 16, wherein a radio access network node comprises the processor.
